(19) United States
(12) Patent Application Publication
(10) Pub. No.: US 2026/0148657 A1
(43) Pub. Date: May 28, 2026

(54) VEHICLE DRIVING SIMULATOR

(71) Applicant: SUBARU CORPORATION, Tokyo (JP)

(72) Inventors: Kou SASAKI, Tokyo (JP); Yuichiro TSUKASAKI, Tokyo (JP)

(21) Appl. No.: 19/381,923

(22) Filed: Nov. 6, 2025

(30) Foreign Application Priority Data
Nov. 28, 2024 (JP) 2024-207369

(51) Int. Cl. G09B 9/05

(52) U.S. Cl. CPC G09B 9/05

(57) ABSTRACT

A vehicle driving simulator includes a steering wheel, a picture generator, a display surface, a laser light source, and a conversion unit. The picture generator is configured to generate an on-road picture. The on-road picture is displayable on the display surface. The laser light source is configured to generate a laser pattern on the display surface. The conversion unit is configured to convert rotation of the steering wheel into displacement of the laser light source in a horizontal direction.

### CROSS-REFERENCE TO RELATED APPLICATIONS

The present application claims priority from Japanese Patent Application No. 2024-207369 filed on Nov. 28, 2024, the entire contents of which are hereby incorporated by reference.

### BACKGROUND

The disclosure relates to a vehicle driving simulator.

Most vehicles that ordinary drivers find easy to drive feature, for example, high steering responsiveness in a minute steering region within a steering angle range of less than or equal to 1 degree. The ordinary drivers, however, have difficulty in noticing that the ease of driving is attributable to the high steering responsiveness in the minute steering region.

An existing measure to allow the ordinary driver to experience the high steering responsiveness in the minute steering region involves causing the ordinary driver to learn a difference in a turning behavior by obtaining advice from an expert driver who rides together in the vehicle that the ordinary driver drives. The advice includes: a steering operation that demonstrates a clear difference between a turning behavior arising from high steering responsiveness and a turning behavior arising from low steering responsiveness; and a part, of the turning behavior arising during the steering operation, to pay attention to. This measure, however, necessitates the expert driver riding together in the vehicle that the ordinary driver drives. This limits the number of ordinary drivers who can learn the difference in the turning behavior in a certain time period.

A conceivable measure to address this concern involves allowing the driver to experience the high steering responsiveness in the minute steering region using a vehicle driving simulator. Such a vehicle driving simulator is disclosed in Japanese Examined Patent Application Publication No. S56-017667.

### SUMMARY

An aspect of the disclosure provides a vehicle driving simulator. The vehicle driving simulator includes a steering wheel, a picture generator, a display surface, a laser light source, and a conversion unit. The picture generator is configured to generate an on-road picture. The on-road picture is displayable on the display surface. The laser light source is configured to generate a laser pattern on the display surface. The conversion unit is configured to convert rotation of the steering wheel into displacement of the laser light source in a horizontal direction.

An aspect of the disclosure provides a vehicle driving simulator. The vehicle driving simulator includes a steering wheel, a picture generator, a display surface, a laser light source, and circuitry. The picture generator is configured to generate an on-road picture. The on-road picture is displayable on the display surface. The laser light source is configured to generate a laser pattern on the display surface. The circuitry is configured to convert rotation of the steering wheel into displacement of the laser light source in a horizontal direction.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating an exemplary configuration of a vehicle driving simulator according to one example embodiment of the disclosure.

FIG. 2 is a diagram illustrating an example of how an area ahead of a simulated vehicle illustrated in FIG. 1 is viewed from an inside of the simulated vehicle.

FIG. 3 is a schematic diagram illustrating an exemplary configuration of a conversion unit illustrated in FIG. 1.

FIG. 4 is a diagram illustrating a modification example of the conversion unit illustrated in FIGS. 1 and 3.

FIG. 5 is a diagram illustrating a modification example of the conversion unit illustrated in FIGS. 1 and 3.

FIG. 6 is a diagram illustrating a modification example of the conversion unit illustrated in FIGS. 1 and 3.

FIG. 7 is a schematic diagram illustrating an exemplary configuration of a vehicle driving simulator according to one example embodiment of the disclosure.

FIG. 8 is a schematic diagram illustrating an exemplary configuration of a conversion unit illustrated in FIG. 7.

FIG. 9 is a diagram illustrating a modification example of the conversion unit illustrated in FIGS. 7 and 8.

FIG. 10 is a diagram illustrating a modification example of the conversion unit illustrated in FIGS. 7 and 8.

FIG. 11 is a diagram illustrating a modification example of the conversion unit illustrated in FIGS. 7 and 8.

FIG. 12 is a schematic diagram illustrating an exemplary configuration of a vehicle driving simulator according to one example embodiment of the disclosure.

FIG. 13 is a schematic diagram illustrating an exemplary configuration of a conversion unit illustrated in FIG. 12.

FIG. 14 is a diagram illustrating a modification example of the conversion unit illustrated in FIGS. 12 and 13.

FIG. 15 is a diagram illustrating a modification example of the conversion unit illustrated in FIGS. 12 and 13.

FIG. 16 is a diagram illustrating a modification example of the conversion unit illustrated in FIGS. 12 and 13.

### DETAILED DESCRIPTION

### 1. Background

Most vehicles that ordinary drivers find easy to drive feature, for example, high steering responsiveness in a minute steering region within a steering angle range of less than or equal to 1 degree. The ordinary drivers, however, have difficulty in noticing that the ease of driving is attributable to the high steering responsiveness in the minute steering region.

An existing measure to allow the ordinary driver to experience the high steering responsiveness in the minute steering region involves causing the ordinary driver to learn a difference in a turning behavior by obtaining advice from an expert driver who rides together in the vehicle that the ordinary driver drives. The advice includes: a steering operation that demonstrates a clear difference between a turning behavior arising from high steering responsiveness and a turning behavior arising from low steering responsiveness; and a part, of the turning behavior arising during the steering operation, to pay attention to. This measure, however, necessitates the expert driver riding together in the vehicle that the ordinary driver drives. This limits the number of ordinary drivers who can learn the difference in the turning behavior in a certain time period.

A conceivable measure to address this concern involves allowing the driver to experience the high steering responsiveness in the minute steering region using a vehicle driving simulator. The vehicle driving simulator, however, can cause various delays such as a delay in providing feedback on a steering force to the driver or a delay in screen drawing. The delays can prevent the driver from experiencing the high steering responsiveness in the minute steering region. It is desirable to provide a vehicle driving simulator that makes it possible to allow a driver to experience high steering responsiveness in a minute steering region.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 2. First Example Embodiment

### Configuration Example

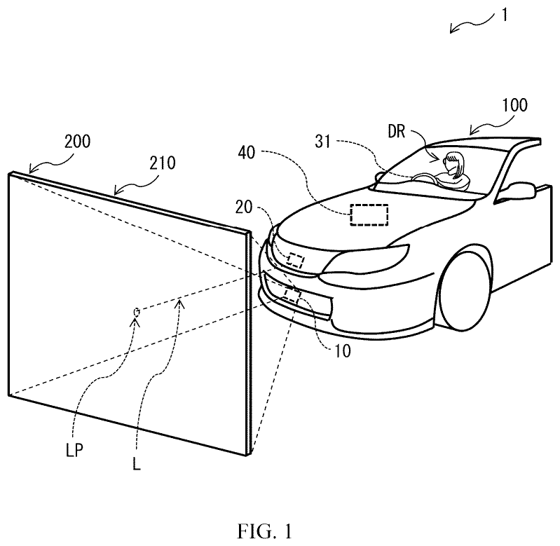

First, a vehicle driving simulator 1 according to a first example embodiment of the disclosure will be described. FIG. 1 schematically illustrates an exemplary configuration of the vehicle driving simulator 1. In the example illustrated in FIG. 1, the vehicle driving simulator 1 may include a simulated vehicle 100 and a screen 200. The screen 200 may include a display surface 210 on which a picture is displayable. In one embodiment, the vehicle driving simulator 1 may serve as a “vehicle driving simulator”. In one embodiment, the display surface 210 may serve as a “display surface”.

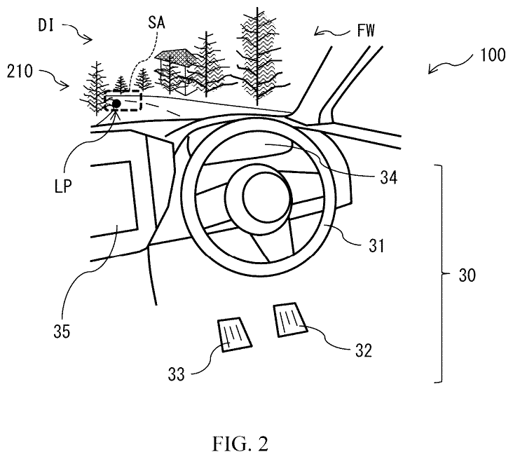

FIG. 2 illustrates an example of how the display surface 210 of the screen 200 is viewed from an inside of the simulated vehicle 100. In the examples illustrated in FIGS. 1 and 2, the simulated vehicle 100 may include a picture generator 10, a laser light source 20, a human-machine interface (HMI) 30, and a conversion unit 40. In one embodiment, the picture generator 10 may serve as a “picture generator”. In one embodiment, the laser light source 20 may serve as a “laser light source”. In one embodiment, the conversion unit 40 may serve as a “conversion unit”.

The picture generator 10 is configured to generate an on-road picture DI. In some embodiments, the picture generator 10 may include a light source, a light bulb, and an optical system. The light source may be configured to generate red light, blue light, and green light. The light bulb may be configured to perform spatial modulation of the red light, the blue light, and the green light, based on a picture signal. The optical system may be configured to combine a red picture, a blue picture, and a green picture generated by the spatial modulation by the light bulb and thereby generate the on-road picture DI. The picture generator 10 may be configured to output the generated on-road picture DI onto the display surface 210.

The laser light source 20 may be configured to generate laser light L and output the laser light L onto the display surface 210. The laser light source 20 may be configured to generate a predetermined laser pattern LP on the display surface 210 by applying the laser light L onto the display surface 210. In some embodiments, the laser light source 20 may include a semiconductor laser configured to output monochromatic laser light. The laser pattern LP may have, for example but not limited to, a spot shape illustrated in FIG. 2.

The laser light source 20 may be configured to, when a steering wheel 31 is not operated, generate the laser pattern LP in a predetermined region SA that includes a far end of a traveling road present in the on-road picture DI displayed on the display surface 210. Illustrated in FIG. 2 is an example of how the on-road picture DI ahead of the simulated vehicle 100 is visually recognizable together with the laser pattern LP through a windshield FW. Note that FIG. 2 illustrates the predetermined region SA on the display surface 210; however, the predetermined region SA may not be displayed on the actual display surface 210.

In the example illustrated in FIG. 2, the HMI 30 may include components such as the steering wheel 31, an accelerator pedal 32, a brake pedal 33, a meter panel display 34, or a center panel display 35. In some embodiments, the meter panel display 34 may include a display panel such as a liquid crystal display panel or an organic electroluminescence (EL) display panel, and may be configured to display information such as a vehicle speed or an engine speed. In some embodiments, the center panel display 35 may include a display panel such as a touch-input liquid crystal display panel or a touch-input organic EL display panel, and may be configured to allow various settings of the simulated vehicle 100.

The conversion unit 40 is configured to convert rotation of the steering wheel 31 into displacement of the laser light source 20 in a horizontal direction. The conversion unit 40 may be configured to mechanically transmit the rotation of the steering wheel 31 to the laser light source 20. In the example illustrated in FIG. 3, the conversion unit 40 may be a power transmission component including a first pulley 41, a second pulley 42, a belt 43, and a transmitter 44. The first pulley 41 and the second pulley 42 may have respective radii different from each other.

The first pulley 41 may be fixed to the steering wheel 31 via the transmitter 44. The second pulley 42 may be fixed to the laser light source 20. The belt 43 may be configured to convert rotation of the first pulley 41 into power adapted to rotate the second pulley 42, and transmit the power to the second pulley 42. The transmitter 44 may be configured to transmit the rotation of the steering wheel 31 to the first pulley 41. The transmitter 44 may include couplers 44a and 44b and a converter 44c. The coupler 44a may be disposed on a rotation axis of the steering wheel 31 and coupled to the steering wheel 31. The coupler 44b may be disposed on a rotation axis of the converter 44c and coupled to the converter 44c. The converter 44c may be configured to convert rotation of the coupler 44a (the steering wheel 31) into power adapted to rotate the coupler 44b, and transmit the power to the coupler 44b. In some embodiments, the converter 44c may include a first gear and a second gear. The first gear may have the same rotation axis as that of the coupler 44a. The second gear may be fitted to the first gear and have the same rotation axis as that of the coupler 44b. The coupler 44b may be disposed on a rotation axis of the first pulley 41 and coupled to the first pulley 41.

### Operation

Next, an exemplary operation of the vehicle driving simulator 1 will be described.

A driver DR who drives the simulated vehicle 100 may sit in a driver's seat of the simulated vehicle 100. In one example, the driver DR may operate the center panel display 35 to thereby cause the picture generator 10 to output the on-road picture DI onto the display surface 210 and cause the laser light source 20 to output the laser light L onto the display surface 210. As a result, the on-road picture DI may be displayed on the display surface 210 of the screen 200, and the laser pattern LP may be displayed in the predetermined region SA that includes the far end of the traveling road present in the on-road picture DI displayed on the display surface 210.

The driver DR may operate the steering wheel 31 in the minute steering region within a steering angle range of less than or equal to 1 degree. At this time, the rotation of the steering wheel 31 may be converted by the converter 44c into the power adapted to rotate the coupler 44b, and the power may be transmitted to the first pulley 41. This may cause the rotation of the first pulley 41 in accordance with the rotation of the steering wheel 31. The rotation of the first pulley 41 may be converted by the belt 43 into the power adapted to rotate the second pulley 42, and the power may be transmitted to the second pulley 42. This may cause rotation of the second pulley 42 in accordance with the rotation of the first pulley 41. The second pulley 42 may have a rotation amount determined by a rotation amount of the first pulley 41 and a pulley ratio between the first pulley 41 and the second pulley 42. The rotation of the second pulley 42 may cause rotation of the laser light source 20 fixed to the second pulley 42. As a result, the laser pattern LP may be displaced on the display surface 210 in a lateral direction of the display surface 210 in accordance with the rotation of the laser light source 20.

The driver DR may visually recognize that the laser pattern LP is displaced on the display surface 210 in the lateral direction in response to the operation of the steering wheel 31 with high responsiveness. This helps to allow the driver DR to experience high operation responsiveness of the steering wheel 31.

### Example Effects

Next, some example effects of the vehicle driving simulator 1 will be described.

In some embodiments, the rotation of the steering wheel 31 by the driver DR may be converted by the mechanical conversion unit 40 into the displacement of the laser light source 20 in the horizontal direction. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, when the steering wheel 31 is not operated, the laser pattern LP may be generated in the predetermined region SA that includes the far end of the traveling road present in the on-road picture DI displayed on the display surface 210. Such a configuration may cause, when the driver DR operates the steering wheel 31 in the minute steering region within the steering angle range of less than or equal to 1 degree, the laser pattern LP to move in the predetermined region SA on the display surface 210 in the lateral direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the rotation of the steering wheel 31 may be mechanically transmitted by the mechanical conversion unit 40 to the laser light source 20. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the conversion unit 40 may include: the first pulley 41 fixed to the steering wheel 31; the second pulley 42 fixed to the laser light source 20; and the belt 43 configured to convert the rotation of the first pulley 41 into the power adapted to rotate the second pulley 42, and transmit the power to the second pulley 42. Such a configuration may cause, when the rotation of the steering wheel 31 by the driver DR is converted by the conversion unit 40 into the displacement of the laser light source 20 in the horizontal direction, the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the first pulley 41 and the second pulley 42 may have the respective radii different from each other. Such a configuration may cause the rotation amount of the second pulley 42 to be determined by the pulley ratio between the radius of the first pulley 41 and the radius of the second pulley 42 and the rotation amount of the first pulley 41. Adjustment of the pulley ratio may thus allow the laser pattern LP to move in the predetermined region SA on the display surface 210 in the lateral direction. At this time, the driver DR is able to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

### 2. Modification Examples of First Example Embodiment

Next, modification examples of the vehicle driving simulator 1 according to the first example embodiment will be described.

### Modification Example 2-1

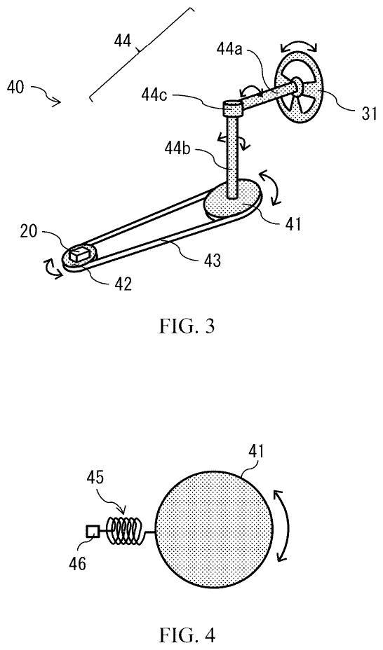

FIG. 4 illustrates a modification example of the conversion unit 40. In some embodiments, the conversion unit 40 may include a reaction force generation mechanism. The reaction force generation mechanism may be configured to, when the first pulley 41 rotates in response to the operation of the steering wheel 31, apply power in an opposite direction to a direction of the rotation to the first pulley 41 in accordance with the rotation. Non-limiting examples of the reaction force generation mechanism may include a spring 45 coupled to a circumferential surface of the first pulley 41, illustrated in FIG. 4. The spring 45 may be coupled to a support 46 fixed to a vehicle body of the simulated vehicle 100. The spring 45 may be configured to, when the first pulley 41 starts rotating clockwise, apply counterclockwise power to the first pulley 41. The spring 45 may be configured to, when the first pulley 41 starts rotating counterclockwise, apply clockwise power to the first pulley 41.

In the present modification example, the conversion unit 40 may include the reaction force generation mechanism such as the spring 45. Such a configuration helps to apply a steering reaction force to the steering wheel 31. This helps to allow the driver DR to experience an operation feeling of the steering wheel 31 close to a feeling in actual driving.

### Modification Example 2-2

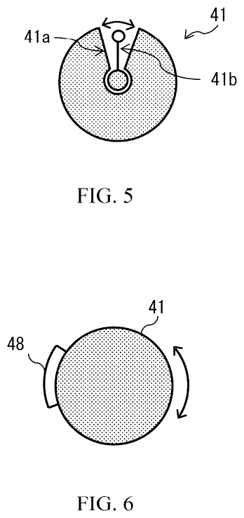

FIG. 5 illustrates a modification example of the conversion unit 40. In some embodiments, the first pulley 41 may include a response adjustment mechanism at a coupling part of the first pulley 41 to the steering wheel 31. The response adjustment mechanism may be configured to, when the steering wheel 31 rotates in a predetermined angular range, relatively decrease responsiveness of the first pulley 41, and when the steering wheel 31 rotates in an angular range greater than the predetermined angular range, relatively increase the responsiveness of the first pulley 41. Non-limiting examples of the response adjustment mechanism may include a notch 41a and an interference member 41b that are provided at the coupling part of the first pulley 41 to the steering wheel 31, illustrated in FIG. 5.

The notch 41a may be, for example but not limited to, a fan-shaped gap in the first pulley 41. The interference member 41b of the first pulley 41 may be separated from a part of the first pulley 41 other than the interference member 41b (hereinafter referred to as a “body”). The interference member 41b may be configured to rotate around the same rotation axis as that of the body. The interference member 41b may include a rod-shaped part extending in the notch 41a. The rod-shaped part may be configured to rotate around the same rotation axis as that of the coupler 44b in an inner space of the notch 41a in accordance with the rotation of the coupler 44b. The rod-shaped part may be configured to, upon hitting an inner wall of the notch 41a after rotating in accordance with the rotation of the coupler 44b, rotate together with the body while pushing the body. The steering wheel 31 may have a clearance determined by a rotation amount of the rod-shaped part and the coupler 44b from a start of the rotation of the rod-shaped part in accordance with the rotation of the coupler 44b to hitting of the rod-shaped part against the inner wall of the notch 41a.

In the present modification example, the conversion unit 40 may include the response adjustment mechanism, such as the notch 41a and the interference member 41b, that defines the clearance of the steering wheel 31. Such a configuration helps to provide the clearance to the steering wheel 31.

### Modification Example 2-3

FIG. 6 illustrates a modification example of the conversion unit 40. In some embodiments, the conversion unit 40 may include a friction mechanism. The friction mechanism may be configured to cause friction against the rotation of the first pulley 41. Non-limiting examples of the friction mechanism may include a friction member 48 in contact with the circumferential surface of the first pulley 41, illustrated in FIG. 6. The friction member 48 may include a rough surface in contact with the circumferential surface of the first pulley 41.

In the present modification example, the conversion unit 40 may include the friction mechanism such as the friction member 48. Such a configuration helps to apply the steering reaction force to the steering wheel 31. This helps to allow the driver DR to experience the operation feeling of the steering wheel 31 close to the feeling in actual driving.

### 3. Second Example Embodiment

### Configuration Example

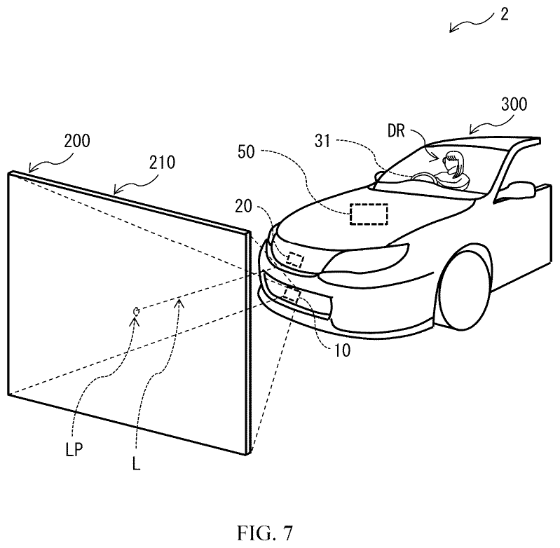

Next, a vehicle driving simulator 2 according to a second example embodiment of the disclosure will be described. FIG. 7 schematically illustrates an exemplary configuration of the vehicle driving simulator 2. In the example illustrated in FIG. 7, the vehicle driving simulator 2 may include a simulated vehicle 300 and the screen 200. The simulated vehicle 300 may have, for example but not limited to, a configuration of the simulated vehicle 100 in which the conversion unit 40 is replaced by a conversion unit 50, as illustrated in FIG. 7. In one embodiment, the conversion unit 50 may serve as the “conversion unit”.

The conversion unit 50 is configured to convert the rotation of the steering wheel 31 into the displacement of the laser light source 20 in the horizontal direction. The conversion unit 50 may be configured to mechanically transmit the rotation of the steering wheel 31 to the laser light source 20. In the example illustrated in FIG. 8, the conversion unit 50 may be a power transmission component including a lever 51, a support 52, and a transmitter 53.

The lever 51 may have a rod shape including a first end to which the laser light source 20 is fixed. The support 52 may support the lever 51 to allow the lever 51 to rotate in a predetermined plane. The support 52 may support the lever 51 at a part different from a center in a longitudinal direction of the lever 51. The transmitter 53 may be configured to convert the rotation of the steering wheel 31 into power adapted to displace the lever 51 in the horizontal direction, and transmit the power to a second end of the lever 51.

The transmitter 53 may include couplers 53a and 53b and converters 53c and 53d. The coupler 53a may be disposed on the rotation axis of the steering wheel 31 and coupled to the steering wheel 31. The coupler 53b may be disposed on a rotation axis of the converter 53c and coupled to the converter 53c. The converter 53c may be configured to transmit the rotation of the coupler 53a (the steering wheel 31) to the converter 53d. The converter 53d may be configured to convert the rotation of the coupler 53b into power adapted to rotate the lever 51, and transmit the power to the lever 51. In some embodiments, the converter 53c may include a first gear and a second gear. The first gear may have the same rotation axis as that of the coupler 53a. The second gear may be fitted to the first gear and have the same rotation axis as that of the coupler 53b. In some embodiments, the converter 53d may include a third gear and a fourth gear. The third gear may have the same rotation axis as that of the coupler 53b. The fourth gear may be fitted to the third gear and have the same rotation axis as that of the lever 51.

### Operation

Next, an exemplary operation of the vehicle driving simulator 2 will be described.

The driver DR who drives the simulated vehicle 300 may sit in a driver's seat of the simulated vehicle 300. In one example, the driver DR may operate the center panel display 35 to thereby cause the picture generator 10 to output the on-road picture DI onto the display surface 210 and cause the laser light source 20 to output the laser light L onto the display surface 210. As a result, the on-road picture DI may be displayed on the display surface 210 of the screen 200, and the laser pattern LP may be displayed in the predetermined region SA that includes the far end of the traveling road present in the on-road picture DI displayed on the display surface 210.

The driver DR may operate the steering wheel 31 in the minute steering region within the steering angle range of less than or equal to 1 degree. At this time, the rotation of the steering wheel 31 may be converted by the converter 53c into power adapted to rotate the coupler 53b. The power may be converted by the converter 53d into the power adapted to rotate the lever 51, and the resultant power may be transmitted to the lever 51. This may cause the rotation of the lever 51 in accordance with the rotation of the steering wheel 31. A rotation amount of the first end of the lever 51 provided with the laser light source 20 may be determined by a rotation amount of the second end of the lever 51 adjacent to the converter 53d, as well as a support distribution ratio (or a support ratio) in the longitudinal direction of the lever 51, determined by the support 52 supporting the lever 51. The rotation of the lever 51 may cause the rotation of the laser light source 20 fixed to the lever 51. As a result, the laser pattern LP may be displaced on the display surface 210 in the lateral direction in accordance with the rotation of the laser light source 20.

The driver DR may visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

### Example Effects

Next, some example effects of the vehicle driving simulator 2 will be described.

In some embodiments, the rotation of the steering wheel 31 by the driver DR may be converted by the mechanical conversion unit 50 into the displacement of the laser light source 20 in the horizontal direction. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, when the steering wheel 31 is not operated, the laser pattern LP may be generated in the predetermined region SA that includes the far end of the traveling road present in the on-road picture DI displayed on the display surface 210. Such a configuration may cause, when the driver DR operates the steering wheel 31 in the minute steering region within the steering angle range of less than or equal to 1 degree, the laser pattern LP to move in the predetermined region SA on the display surface 210 in the lateral direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the rotation of the steering wheel 31 may be mechanically transmitted by the mechanical conversion unit 50 to the laser light source 20. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the conversion unit 50 may include: the lever 51 including the first end to which the laser light source 20 is fixed; the support 52 rotatably supporting the lever 51; and the transmitter 53 configured to convert the rotation of the steering wheel 31 into the power adapted to displace the lever 51 in the horizontal direction, and transmit the power to the second end of the lever 51. Such a configuration may cause, when the rotation of the steering wheel 31 by the driver DR is converted by the conversion unit 50 into the displacement of the laser light source 20 in the horizontal direction, the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the lever 51 may be supported by the support 52 at the part different from the center in the longitudinal direction of the lever 51. Such a configuration may cause a displacement amount of the laser light source 20 to be determined by a displacement amount of the converter 53d and the support ratio between a distance from the part of the lever 51 supported by the support 52 to the first end of the lever 51 and a distance from the part of the lever 51 supported by the support 52 to the second end of the lever 51. Adjustment of the support ratio may thus allow the laser pattern LP to move in the predetermined region SA on the display surface 210 in the lateral direction. At this time, the driver DR is able to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

### 4. Modification Examples of Second Example Embodiment

Next, modification examples of the vehicle driving simulator 2 according to the second example embodiment will be described.

### Modification Example 4-1

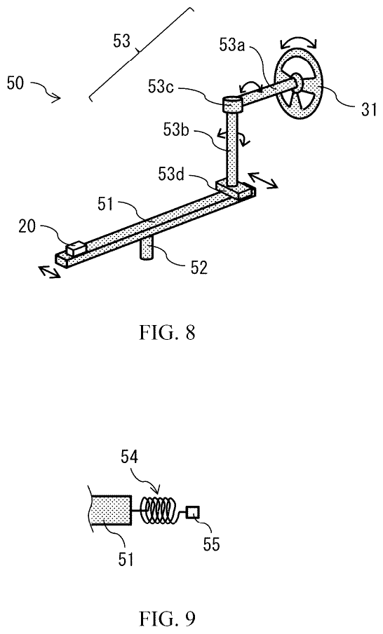

FIG. 9 illustrates a modification example of the conversion unit 50. In some embodiments, the conversion unit 50 may include a reaction force generation mechanism. The reaction force generation mechanism may be configured to, when the lever 51 rotates in response to the operation of the steering wheel 31, apply power in an opposite direction to a direction of the rotation to the lever 51 in accordance with the rotation. Non-limiting examples of the reaction force generation mechanism may include a spring 54 coupled to a circumferential surface of the lever 51, illustrated in FIG. 9. The spring 54 may be coupled to a support 55 fixed to a vehicle body of the simulated vehicle 300. The spring 54 may be configured to, when the lever 51 starts rotating clockwise, apply counterclockwise power to the lever 51. The spring 54 may be configured to, when the lever 51 starts rotating counterclockwise, apply clockwise power to the lever 51.

In the present modification example, the conversion unit 50 may include the reaction force generation mechanism such as the spring 54. Such a configuration helps to apply the steering reaction force to the steering wheel 31. This helps to allow the driver DR to experience the operation feeling of the steering wheel 31 close to the feeling in actual driving.

### Modification Example 4-2

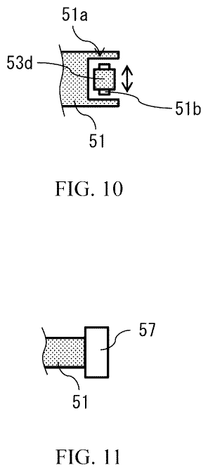

FIG. 10 illustrates a modification example of the conversion unit 50. In some embodiments, the lever 51 may include a response adjustment mechanism at a tip of the lever 51. The response adjustment mechanism may be configured to, when the steering wheel 31 rotates in a predetermined angular range, relatively decrease responsiveness of the lever 51, and when the steering wheel 31 rotates in an angular range greater than the predetermined angular range, relatively increase the responsiveness of the lever 51. Non-limiting examples of the response adjustment mechanism may include a notch 51a and an interference member 51b that are provided at the tip of the lever 51, illustrated in FIG. 10.

In some embodiments, the notch 51a may be a recess provided at the tip of the lever 51. The converter 53d may be provided inside the notch 51a and spaced apart from the lever 51. To the converter 53d may be coupled the interference member 51b. The converter 53d may be configured to convert the rotation of the coupler 53b into power adapted to displace the interference member 51b in the same direction as a rotation direction of the lever 51, and transmit the power to the interference member 51b. The interference member 51b may be configured to be displaced in the same direction as the rotation direction of the lever 51 in an inner space of the notch 51a in accordance with the power received from the converter 53d. The interference member 51b may be configured to, upon hitting an inner wall of the notch 51a after being displaced in accordance with the power received from the converter 53d, be displaced together with the lever 51 while pushing the lever 51. The steering wheel 31 may have a clearance determined by a displacement amount of the interference member 51b from a start of the displacement of the interference member 51b in accordance with the power received from the converter 53d to hitting of the interference member 51b against the inner wall of the notch 51a.

In the present modification example, the conversion unit 50 may include the response adjustment mechanism, such as the notch 51a and the interference member 51b, that defines the clearance of the steering wheel 31. Such a configuration helps to provide the clearance to the steering wheel 31.

### Modification Example 4-3

FIG. 11 illustrates a modification example of the conversion unit 50. In some embodiments, the conversion unit 50 may include a friction mechanism. The friction mechanism may be configured to cause friction against the rotation of the lever 51. Non-limiting examples of the friction mechanism may include a friction member 57 in contact with the tip of the lever 51, illustrated in FIG. 11. The friction member 57 may include a rough surface in contact with the tip of the lever 51.

In the present modification example, the conversion unit 50 may include the friction mechanism such as the friction member 57. Such a configuration helps to apply the steering reaction force to the steering wheel 31. This helps to allow the driver DR to experience the operation feeling of the steering wheel 31 close to the feeling in actual driving.

### 5. Third Example Embodiment

### Configuration Example

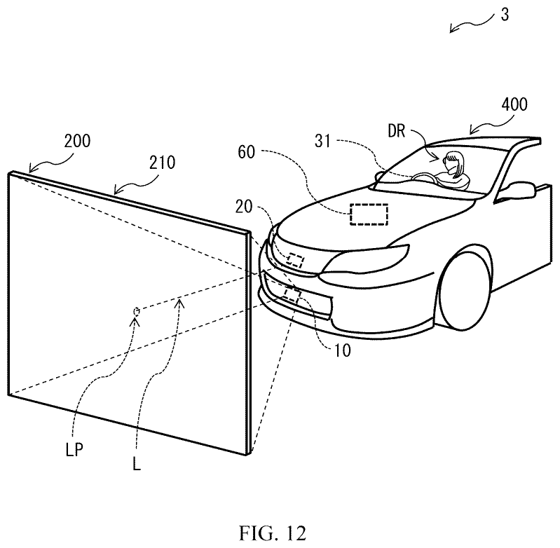

Next, a vehicle driving simulator 3 according to a third example embodiment of the disclosure will be described. FIG. 12 schematically illustrates an exemplary configuration of the vehicle driving simulator 3. In the example illustrated in FIG. 12, the vehicle driving simulator 3 may include a simulated vehicle 400 and the screen 200. The simulated vehicle 400 may have, for example but not limited to, a configuration of the simulated vehicle 100 in which the conversion unit 40 is replaced by a conversion unit 60, as illustrated in FIG. 12. In one embodiment, the conversion unit 60 may serve as the “conversion unit”.

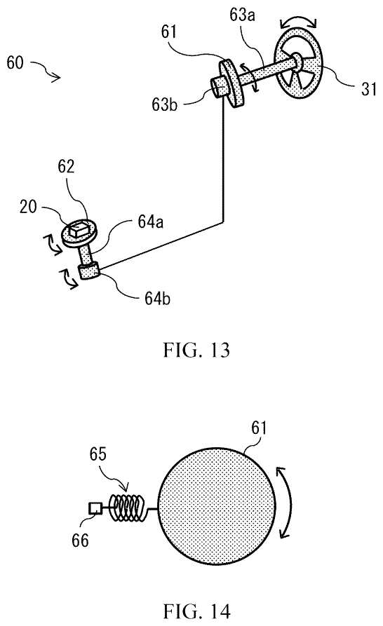

The conversion unit 60 is configured to convert the rotation of the steering wheel 31 into the displacement of the laser light source 20 in the horizontal direction. The conversion unit 60 may be configured to electrically transmit the rotation of the steering wheel 31 to the laser light source 20. In the example illustrated in FIG. 13, the conversion unit 60 may be a power transmission component including a first pulley 61, a second pulley 62, couplers 63a and 64a, a sensor 63b, and a driver 64b. The first pulley 61 and the second pulley 62 may have respective radii different from each other. In one embodiment, the driver 64b may serve as an “actuator”.

The first pulley 61 may be fixed to the steering wheel 31 via the coupler 63a. The second pulley 62 may be fixed to the laser light source 20. The sensor 63b may be configured to detect rotation of the first pulley 61 and output a detection result (a detection signal) to the driver 64b. The driver 64b may be configured to generate power adapted to rotate the second pulley 62 via the coupler 64a, based on the detection result (the detection signal) received from the sensor 63b, and transmit the power to the second pulley 62. The coupler 63a may be disposed on the rotation axis of the steering wheel 31 and coupled to the steering wheel 31. The coupler 63a may be disposed on a rotation axis of the first pulley 61 and coupled to the first pulley 61. The coupler 64a may be disposed on a rotation axis of the driver 64b and coupled to the driver 64b. The coupler 64a may be disposed on a rotation axis of the second pulley 62 and coupled to the second pulley 62.

### Operation

Next, an exemplary operation of the vehicle driving simulator 3 will be described.

The driver DR who drives the simulated vehicle 400 may sit in a driver's seat of the simulated vehicle 400. In one example, the driver DR may operate the center panel display 35 to thereby cause the picture generator 10 to output the on-road picture DI onto the display surface 210 and cause the laser light source 20 to output the laser light L onto the display surface 210. As a result, the on-road picture DI may be displayed on the display surface 210 of the screen 200, and the laser pattern LP may be displayed in the predetermined region SA that includes the far end of the traveling road present in the on-road picture DI displayed on the display surface 210.

The driver DR may operate the steering wheel 31 in the minute steering region within the steering angle range of less than or equal to 1 degree. At this time, the rotation of the steering wheel 31 may be converted by the coupler 63a into power adapted to rotate the first pulley 61. The rotation of the first pulley 61 with the power may be detected by the sensor 63b, and the detection result (the detection signal) may be outputted to the driver 64b. The power adapted to rotate the second pulley 62 via the coupler 64a may be generated by the driver 64b, based on the detection result (the detection signal) received from the sensor 63b, and the power may be transmitted to the second pulley 62. The rotation of the second pulley 62 may cause the rotation of the laser light source 20 fixed to the second pulley 62. As a result, the laser pattern LP may be displaced on the display surface 210 in the lateral direction in accordance with the rotation of the laser light source 20.

The driver DR may visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

### Example Effects

Next, some example effects of the vehicle driving simulator 3 will be described.

In some embodiments, the rotation of the steering wheel 31 by the driver DR may be converted by the electrical conversion unit 60 into the displacement of the laser light source 20 in the horizontal direction. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, when the steering wheel 31 is not operated, the laser pattern LP may be generated in the predetermined region SA that includes the far end of the traveling road present in the on-road picture DI displayed on the display surface 210. Such a configuration may cause, when the driver DR operates the steering wheel 31 in the minute steering region within the steering angle range of less than or equal to 1 degree, the laser pattern LP to move in the predetermined region SA on the display surface 210 in the lateral direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the rotation of the steering wheel 31 may be electrically transmitted by the electrical conversion unit 60 to the laser light source 20. Such a configuration may cause the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

In some embodiments, the conversion unit 60 may include: the first pulley 61 fixed to the steering wheel 31; the second pulley 62 fixed to the laser light source 20; the sensor 63b configured to detect the rotation of the first pulley 61; and the driver 64b configured to generate the power adapted to rotate the second pulley 62, based on an output of the sensor 63b, and rotate the second pulley 62 with the power. Such a configuration may cause, when the rotation of the steering wheel 31 by the driver DR is converted by the conversion unit 60 into the displacement of the laser light source 20 in the horizontal direction, the laser pattern LP to be displaced on the display surface 210 in the lateral direction in accordance with the displacement of the laser light source 20 in the horizontal direction. This helps to allow the driver DR to visually recognize that the laser pattern LP is displaced on the display surface 210 in the lateral direction in response to the operation of the steering wheel 31 with high responsiveness. This helps to allow the driver DR to experience the high operation responsiveness of the steering wheel 31.

### 6. Modification Examples of Third Example Embodiment

Next, modification examples of the vehicle driving simulator 3 according to the third example embodiment will be described.

### Modification Example 6-1

FIG. 14 illustrates a modification example of the conversion unit 60. In some embodiments, the conversion unit 60 may include a reaction force generation mechanism. The reaction force generation mechanism may be configured to, when the first pulley 61 rotates in response to the operation of the steering wheel 31, apply power in an opposite direction to a direction of the rotation to the first pulley 61 in accordance with the rotation. Non-limiting examples of the reaction force generation mechanism may include a spring 65 coupled to a circumferential surface of the first pulley 61, illustrated in FIG. 14. The spring 65 may be coupled to a support 66 fixed to a vehicle body of the simulated vehicle 400. The spring 65 may be configured to, when the first pulley 61 starts rotating clockwise, apply counterclockwise power to the first pulley 61. The spring 65 may be configured to, when the first pulley 61 starts rotating counterclockwise, apply clockwise power to the first pulley 61.

In the present modification example, the conversion unit 60 may include the reaction force generation mechanism such as the spring 65. Such a configuration helps to apply the steering reaction force to the steering wheel 31. This helps to allow the driver DR to experience the operation feeling of the steering wheel 31 close to the feeling in actual driving.

### Modification Example 6-2

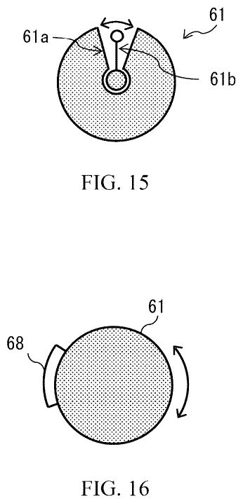

FIG. 15 illustrates a modification example of the conversion unit 60. In some embodiments, the first pulley 61 may include a response adjustment mechanism at a coupling part of the first pulley 61 to the steering wheel 31. The response adjustment mechanism may be configured to, when the steering wheel 31 rotates in a predetermined angular range, relatively decrease responsiveness of the first pulley 61, and when the steering wheel 31 rotates in an angular range greater than the predetermined angular range, relatively increase the responsiveness of the first pulley 61. Non-limiting examples of the response adjustment mechanism may include a notch 61a and an interference member 61b that are provided at the coupling part of the first pulley 61 to the steering wheel 31, illustrated in FIG. 15.

The notch 61a may be, for example but not limited to, a fan-shaped gap in the first pulley 61. The interference member 61b of the first pulley 61 may be separated from a part of the first pulley 61 other than the interference member 61b (hereinafter referred to as a “body”). The interference member 61b may be configured to rotate around the same rotation axis as that of the body. The interference member 61b may include a rod-shaped part extending in the notch 61a. The rod-shaped part may be configured to rotate around the same rotation axis as that of the coupler 63a in an inner space of the notch 61a in accordance with the rotation of the coupler 63a. The rod-shaped part may be configured to, upon hitting an inner wall of the notch 61a after rotating in accordance with the rotation of the coupler 63a, rotate together with the body while pushing the body. The steering wheel 31 may have a clearance determined by a rotation amount of the rod-shaped part and the coupler 63a from a start of the rotation of the rod-shaped part in accordance with the rotation of the coupler 63a to hitting of the rod-shaped part against the inner wall of the notch 61a.

In the present modification example, the conversion unit 60 may include the response adjustment mechanism, such as the notch 61a and the interference member 61b, that defines the clearance of the steering wheel 31. Such a configuration helps to provide the clearance to the steering wheel 31.

### Modification Example 6-3

FIG. 16 illustrates a modification example of the conversion unit 60. In some embodiments, the conversion unit 60 may include a friction mechanism. The friction mechanism may be configured to cause friction against the rotation of the first pulley 61. Non-limiting examples of the friction mechanism may include a friction member 68 in contact with the circumferential surface of the first pulley 61, illustrated in FIG. 16. The friction member 68 may include a rough surface in contact with the circumferential surface of the first pulley 61.

In the present modification example, the conversion unit 60 may include the friction mechanism such as the friction member 68. Such a configuration helps to apply the steering reaction force to the steering wheel 31. This helps to allow the driver DR to experience the operation feeling of the steering wheel 31 close to the feeling in actual driving.

The example effects described herein are merely examples, and effects of the disclosure are not limited to the effects described herein. Accordingly, any other effect may be achieved by any embodiment of the disclosure.

The disclosure may include at least the following configurations.
(1)

A vehicle driving simulator including:
a steering wheel;
a picture generator configured to generate an on-road picture;
a display surface on which the on-road picture is displayable;
a laser light source configured to generate a laser pattern on the display surface; and
a conversion unit configured to convert rotation of the steering wheel into displacement of the laser light source in a horizontal direction.
(2)

The vehicle driving simulator according to (1), in which the laser light source is configured to, when the steering wheel is not operated, generate the laser pattern in a predetermined region that includes a far end of a traveling road present in the on-road picture displayed on the display surface.
(3)

The vehicle driving simulator according to (1) or (2), in which the conversion unit is configured to mechanically transmit the rotation of the steering wheel to the laser light source.
(4)

The vehicle driving simulator according to (1) or (2), in which the conversion unit is configured to electrically transmit the rotation of the steering wheel to the laser light source.
(5)

The vehicle driving simulator according to (3), in which the conversion unit includes a power transmission component including: a first pulley fixed to the steering wheel; a second pulley fixed to the laser light source; and a belt configured to convert rotation of the first pulley into power adapted to rotate the second pulley, and transmit the power to the second pulley.
(6)

The vehicle driving simulator according to (5), in which the first pulley and the second pulley have respective radii different from each other.
(7)

The vehicle driving simulator according to (3), in which the conversion unit includes a power transmission component including: a lever including a first end to which the laser light source is fixed; a support rotatably supporting the lever; and a transmitter configured to convert the rotation of the steering wheel into power adapted to displace the lever in the horizontal direction, and transmit the power to a second end of the lever.
(8)

The vehicle driving simulator according to (7), in which the support supports the lever at a part different from a center in a longitudinal direction of the lever.
(9)

The vehicle driving simulator according to (4), in which the conversion unit includes a power transmission component including: a first pulley fixed to the steering wheel; a second pulley fixed to the laser light source; a sensor configured to detect rotation of the first pulley; and an actuator configured to generate power adapted to rotate the second pulley, based on an output of the sensor, and rotate the second pulley with the power.
(10)

The vehicle driving simulator according to (5) or (9), in which the conversion unit includes a reaction force generation mechanism, the reaction force generation mechanism being configured to, when the first pulley rotates in response to an operation of the steering wheel, apply power in an opposite direction to a direction of the rotation to the first pulley in accordance with the rotation.
(11)

The vehicle driving simulator according to (5) or (9), in which the first pulley includes a response adjustment mechanism at a coupling part of the first pulley to the steering wheel, the response adjustment mechanism being configured to, when the steering wheel rotates in a predetermined angular range, relatively decrease responsiveness of the first pulley, and when the steering wheel rotates in an angular range greater than the predetermined angular range, relatively increase the responsiveness of the first pulley.
(12)

The vehicle driving simulator according to (5) or (9), in which the conversion unit includes a friction mechanism configured to cause friction against the rotation of the first pulley.

In the vehicle driving simulator according to at least one embodiment of the disclosure, the rotation of the steering wheel by a driver is converted by the conversion unit into the displacement of the laser light source in the horizontal direction. Such a configuration causes the laser pattern to be displaced on the display surface in a lateral direction of the display surface in accordance with the displacement of the laser light source in the horizontal direction. This helps to allow the driver to visually recognize that the laser pattern is displaced on the display surface in the lateral direction in response to the operation of the steering wheel with high responsiveness. This helps to allow the driver to experience high operation responsiveness of the steering wheel.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having a similar meaning thereto are defined as being largely but not necessarily wholly what is specified as understood by one of ordinary skill in the art.

The term “disposed on/provided on/formed on” and its variants having a similar meaning thereto as used herein refer to elements disposed directly in contact with each other or indirectly by having intervening structures therebetween.

The picture generator 10 illustrated in FIGS. 1, 7, and 12 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the picture generator 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the picture generator 10 illustrated in FIGS. 1, 7, and 12.

1. A vehicle driving simulator comprising:
a steering wheel;
a picture generator configured to generate an on-road picture;
a display surface on which the on-road picture is displayable;
a laser light source configured to generate a laser pattern on the display surface; and
a conversion unit configured to convert rotation of the steering wheel into displacement of the laser light source in a horizontal direction.

2. The vehicle driving simulator according to claim 1, wherein the laser light source is configured to, when the steering wheel is not operated, generate the laser pattern in a predetermined region that comprises a far end of a traveling road present in the on-road picture displayed on the display surface.

3. The vehicle driving simulator according to claim 1, wherein the conversion unit comprises a power transmission component comprising: a first pulley fixed to the steering wheel; a second pulley fixed to the laser light source; and a belt configured to convert rotation of the first pulley into power adapted to rotate the second pulley, and transmit the power to the second pulley.

4. The vehicle driving simulator according to claim 1, wherein the conversion unit comprises a power transmission component comprising: a lever comprising a first end to which the laser light source is fixed; a support rotatably supporting the lever; and a transmitter configured to convert the rotation of the steering wheel into power adapted to displace the lever in the horizontal direction, and transmit the power to a second end of the lever.

5. The vehicle driving simulator according to claim 1, wherein the conversion unit comprises a power transmission component comprising: a first pulley fixed to the steering wheel; a second pulley fixed to the laser light source; a sensor configured to detect rotation of the first pulley; and an actuator configured to generate power adapted to rotate the second pulley, based on an output of the sensor, and rotate the second pulley with the power.

6. A vehicle driving simulator comprising:
a steering wheel;
a picture generator configured to generate an on-road picture;
a display surface on which the on-road picture is displayable;
a laser light source configured to generate a laser pattern on the display surface; and
circuitry configured to convert rotation of the steering wheel into displacement of the laser light source in a horizontal direction.
